(19) United States
(12) Patent Application Publication
(10) Pub. No.: US 2016/0134401 A1
(43) Pub. Date: May 12, 2016

(54) INTER-CELL INTERFERENCE

(71) Applicant: NOKIA SOLUTIONS AND NETWORKS OY, Espoo (FI)

(72) Inventors: Kari Pekka PAJUKOSKI, Oulu (FI); Esa Tapani TIIROLA, Kempele (FI); Gilberto BERARDINELLI, Aalborg (DK); Fernando TAVARES, Risskov (DK)

(73) Assignee: Nokia Solutions and Network OY, Espoo (FI)

(21) Appl. No.: 14/896,042

(22) PCT Filed: Jun. 6, 2013
(86) PCT No.: PCT/EP2013/061638

§ 371 Date: Dec. 4, 2015

(51) Int. Cl. H04L 5/00; H04W 72/04; H04W 72/08

(52) U.S. Cl. CPC H04L 5/0048; H04W 72/082; H04W 72/0406

(57) ABSTRACT

A technique including: controlling a radio device of a first cell to transmit information identifying one or more radio resources allocated to both downlink and uplink transmissions of a type of reference signal in the first cell; and controlling the radio device to transmit the type of reference signal in the first cell using the one or more radio resources; wherein the one or more radio resources are excluded from use for transmission of the type of reference signal in one or more other interfering cells.

Cellular communication systems can involve the use of interfering (or potentially interfering) radio resources in cells with at least partially overlapping coverage areas, and the use of interference cancellation or interference mitigation techniques that take interfering channels in other cells into account when demodulating transmissions.

There has been identified the challenge of better supporting the use of such interference cancellation or interference mitigation techniques.

An interfering cell may be a cell which may cause interference, such as a neighbour cell having at least partially overlapping radio range, neighbour cell not having an overlapping range, cell located further away, but using a radio resource which may cause interference, for example due to reflection, etc.

According to an aspect of the present invention, there is provided a method comprising: controlling a radio device of a first cell to transmit information identifying one or more radio resources allocated to both downlink and uplink transmissions of a type of reference signal in said first cell; and controlling said radio device to transmit said type of reference signal in said first cell using said one or more radio resources; wherein the one or more radio resources are excluded from use for transmission of said type of reference signal in one or more other interfering cells.

According to another aspect of the present invention, there is provided a method comprising: controlling a radio device to receive information identifying one or more radio resources for both downlink and uplink transmissions of a type of reference signal in a first cell, and excluded from use for transmission of said type of reference signal in one or more interfering cells; and controlling said radio device to transmit the type reference signal using the one or more radio resources.

According to another aspect of the present invention, there is provided an apparatus comprising: a processor and memory including computer program code, wherein the memory and computer program code are configured to, with the processor, cause the apparatus to: control a radio device of a first cell to transmit information identifying one or more radio resources allocated to both downlink and uplink transmissions of a type of reference signal in said first cell; and control said radio device to transmit said type of reference signal in said first cell using said one or more radio resources; wherein the one or more radio resources are excluded from use for transmission of said type of reference signal in one or more other interfering cells.

According to another aspect of the present invention, there is provided an apparatus comprising: a processor and memory including computer program code, wherein the memory and computer program code are configured to, with the processor, cause the apparatus to: control a radio device to receive information identifying one or more radio resources for both downlink and uplink transmissions of a type of reference signal in a first cell, and excluded from use for transmission of said type of reference signal in one or more interfering cells; and control said radio device to transmit the type reference signal using the one or more radio resources.

According to another aspect of the present invention, there is provided an apparatus comprising: means for controlling a radio device of a first cell to transmit information identifying one or more radio resources allocated to both downlink and uplink transmissions of a type of reference signal in said first cell; and means for controlling said radio device to transmit said type of reference signal in said first cell using said one or more radio resources; wherein the one or more radio resources are excluded from use for transmission of said type of reference signal in one or more other interfering cells.

According to another aspect of the present invention, there is provided an apparatus comprising: means for controlling a radio device to receive information identifying one or more radio resources for both downlink and uplink transmissions of a type of reference signal in a first cell, and excluded from use for transmission of said type of reference signal in one or more interfering cells; and means for controlling said radio device to transmit the type reference signal using the one or more radio resources.

According to another aspect of the present invention, there is provided a computer program product comprising program code means which when loaded into a computer controls the computer to: control a radio device of a first cell to transmit information identifying one or more radio resources allocated to both downlink and uplink transmissions of a type of reference signal in said first cell; and control said radio device to transmit said type of reference signal in said first cell using said one or more radio resources; wherein the one or more radio resources are excluded from use for transmission of said type of reference signal in one or more other interfering cells.

According to another aspect of the present invention, there is provided a computer program product comprising program code means which when loaded into a computer controls the computer to: control a radio device to receive information identifying one or more radio resources for both downlink and uplink transmissions of a type of reference signal in a first cell, and excluded from use for transmission of said type of reference signal in one or more interfering cells; and control said radio device to transmit the type reference signal using the one or more radio resources.

According to one embodiment, said one or more radio resources comprises a respective radio resource for each antenna used by the radio device for spatially multiplexed transmissions in the cell.

According to one embodiment, the number of said one or more radio resources allocated to both uplink and downlink transmissions of said type of reference signal in said first cell is no smaller than the maximum transmission rank for spatially multiplexed transmissions in the first cell.

According to one embodiment, said one or more radio resources include at least a first set of one or more radio resources reserved for transmissions in the first cell in a first frequency region, and a second set of one or more radio resources reserved for transmissions in the first cell in a different, second frequency region.

According to one embodiment, said first frequency region is used for transmissions having a higher transmission rank than transmissions via said second frequency region.

According to one embodiment, the type of reference signal is at least one of: demodulation reference signal, channel state information reference signal and sounding reference signal.

According to one embodiment, the one or more radio resources used for both downlink and uplink transmissions in the first cell are at least substantially orthogonal to one more radio resources used for transmissions of said type of reference signal in said one or more other interfering cells.

According to one embodiment, said first cell and said one or more other interfering cells comprise a group of cells, and said one or more radio resources is excluded from use for transmission of said type of reference signal in any other cell within said group of cells.

According to one embodiment, said one or more radio resources comprise a set of sub-carriers; and wherein transmissions of said type of reference signal in each other cell of said group of cells are made using the same time resources as the first cell, and using a different set of sub-carriers.

According to one embodiment, said one or more radio resources includes a set of one or more cyclically shifted versions of a constant amplitude zero autocorrelation sequence; and wherein transmissions of said type of reference signal in each other cell of said group of cells are made using the same frequency-time resources as the first cell, and using a respective different set of one or more cyclically shifted versions of the same constant amplitude zero autocorrelation sequence.

According to one embodiment, said first set of one or more cyclically shifted versions of a constant amplitude zero autocorrelation sequence are commonly used by other radio devices for transmissions of said first type of reference signal in said first cell.

According to one embodiment, said frequency-time resources comprises a predefined part of a physical resource block.

According to one embodiment, the maximum transmission rank for spatially multiplexed transmissions in the first cell is different to the maximum transmission rank in at least one other cell of said group of cells.

According to one embodiment, said first cell is part of a first group of interfering cells for said first frequency region; said first cell is part of a second group of interfering cells for said second frequency region; said first set of one or more radio resources is excluded from use for transmission of said type of reference signal in said first frequency region in any other cell within said first group of cells; and said second set of one or more radio resources is excluded from use for transmission of said type of reference signal in said second frequency region in any other cell within said second group of cells. There is also hereby provided a method comprising: controlling a radio device to receive one or more transmissions in a first cell, which one or more transmissions are subject to interference by one or more transmissions in one or more interfering cells; and demodulating said one or more transmissions in said first cell taking into account interfering channel information (or channel information derived from a signal which has been interfered in a radio path) derived from a type of reference signal transmitted in said one or more other interfering cells using a respective set of one or more radio resources for both uplink and downlink transmissions of said type of reference signal, wherein each respective set of one or more radio resources for a cell of the one or more interfering cells is excluded from use for either downlink or uplink transmission of said type of reference signal in said first cell and any other cell of said one or more interfering cells.

According to one embodiment, the method further comprises selectively taking into account only interfering channel information derived from reference signals having a received strength exceeding a predetermined threshold.

According to another aspect of the present invention, there is provided a method comprising: controlling transmissions in a plurality of interfering cells of one type of reference signal, such that each cell of said plurality of interfering cells uses for both downlink and uplink transmissions of said type of reference signal one or more radio resources that are excluded from use for either downlink or uplink transmissions of said type of reference signal in any other cell of said plurality of interfering cells.

According to another aspect of the present invention, there is provided an apparatus comprising: a processor and memory including computer program code, wherein the memory and computer program code are configured to, with the processor, cause the apparatus to: control a radio device to receive one or more transmissions in a first cell, which one or more transmissions are subject to interference by one or more transmissions in one or more interfering cells; and demodulate said one or more transmissions in said first cell taking into account interfering channel information derived from a type of reference signal transmitted in said one or more other interfering cells using a respective set of one or more radio resources for both uplink and downlink transmissions of said type of reference signal, wherein each respective set of one or more radio resources for a cell of the one or more interfering cells is excluded from use for either downlink or uplink transmission of said type of reference signal in said first cell and any other cell of said one or more interfering cells.

According to one embodiment, the memory and computer program code are further configured to, with the processor, cause the apparatus to: selectively take into account only interfering channel information derived from reference signals having a received strength exceeding a predetermined threshold.

According to another aspect of the present invention, there is provided an apparatus comprising: a processor and memory including computer program code, wherein the memory and computer program code are configured to, with the processor, cause the apparatus to: control transmissions in a plurality of interfering cells of one type of reference signal, such that each cell of said plurality of interfering cells uses for both downlink and uplink transmissions of said type of reference signal one or more radio resources that are excluded from use for either downlink or uplink transmissions of said type of reference signal in any other cell of said plurality of interfering cells.

According to another aspect of the present invention, there is provided an apparatus comprising: means for controlling a radio device to receive one or more transmissions in a first cell, which one or more transmissions are subject to interference by one or more transmissions in one or more interfering cells; and means for demodulating said one or more transmissions in said first cell taking into account interfering channel information derived from a type of reference signal transmitted in said one or more other interfering cells using a respective set of one or more radio resources for both uplink and downlink transmissions of said type of reference signal, wherein each respective set of one or more radio resources for a cell of the one or more interfering cells is excluded from use for either downlink or uplink transmission of said type of reference signal in said first cell and any other cell of said one or more interfering cells.

According to another aspect of the present invention, there is provided an apparatus comprising: means for controlling transmissions in a plurality of interfering cells of one type of reference signal, such that each cell of said plurality of interfering cells uses for both downlink and uplink transmissions of said type of reference signal one or more radio resources that are excluded from use for either downlink or uplink transmissions of said type of reference signal in any other cell of said plurality of interfering cells.

According to another aspect of the present invention, there is provided a computer program product comprising program code means which when loaded into a computer controls the computer to: control a radio device to receive one or more transmissions in a first cell, which one or more transmissions are subject to interference by one or more transmissions in one or more interfering cells; and demodulate said one or more transmissions in said first cell taking into account interfering channel information derived from a type of reference signal transmitted in said one or more other interfering cells using a respective set of one or more radio resources for both uplink and downlink transmissions of said type of reference signal, wherein each respective set of one or more radio resources for a cell of the one or more interfering cells is excluded from use for either downlink or uplink transmission of said type of reference signal in said first cell and any other cell of said one or more interfering cells.

According to another aspect of the present invention, there is provided a computer program product comprising program code means which when loaded into a computer controls the computer to: control transmissions in a plurality of interfering cells of one type of reference signal, such that each cell of said plurality of interfering cells uses for both downlink and uplink transmissions of said type of reference signal one or more radio resources that are excluded from use for either downlink or uplink transmissions of said type of reference signal in any other cell of said plurality of interfering cells.

Some embodiments of the present invention are described in detail hereunder, by way of example only, with reference to the accompanying drawings, in which:

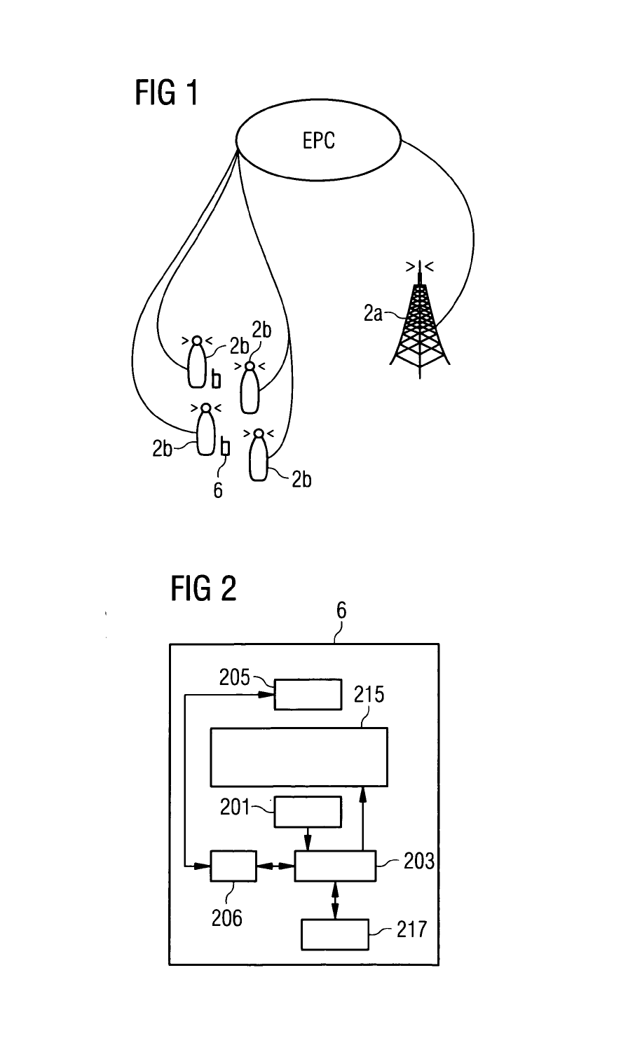

FIG. 1 illustrates an example of a radio access network in which embodiments of the present invention can be implemented;

FIG. 2 illustrates an example of apparatus for a UE in FIG. 1;

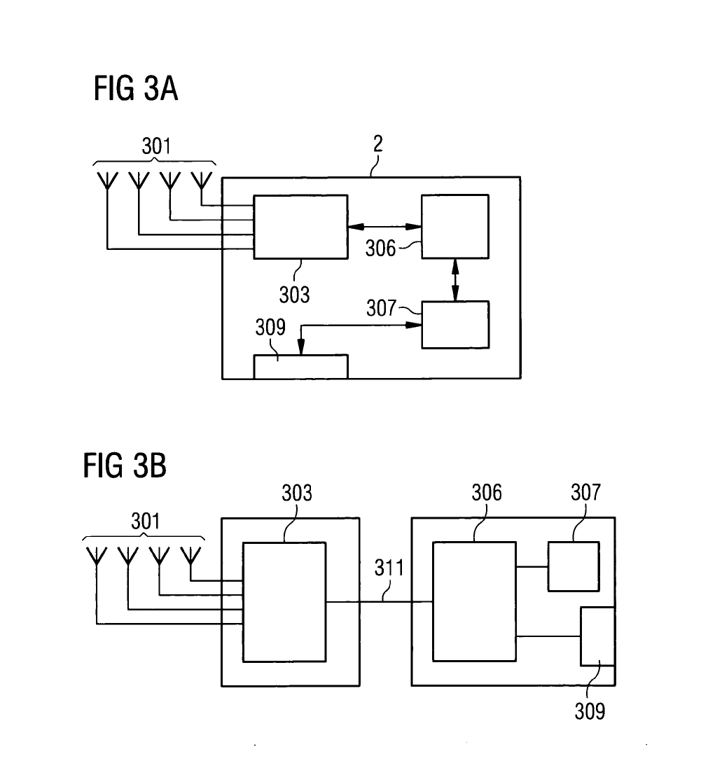

FIGS. 3a and 3b illustrate examples of apparatus for use at an access node in FIG. 1;

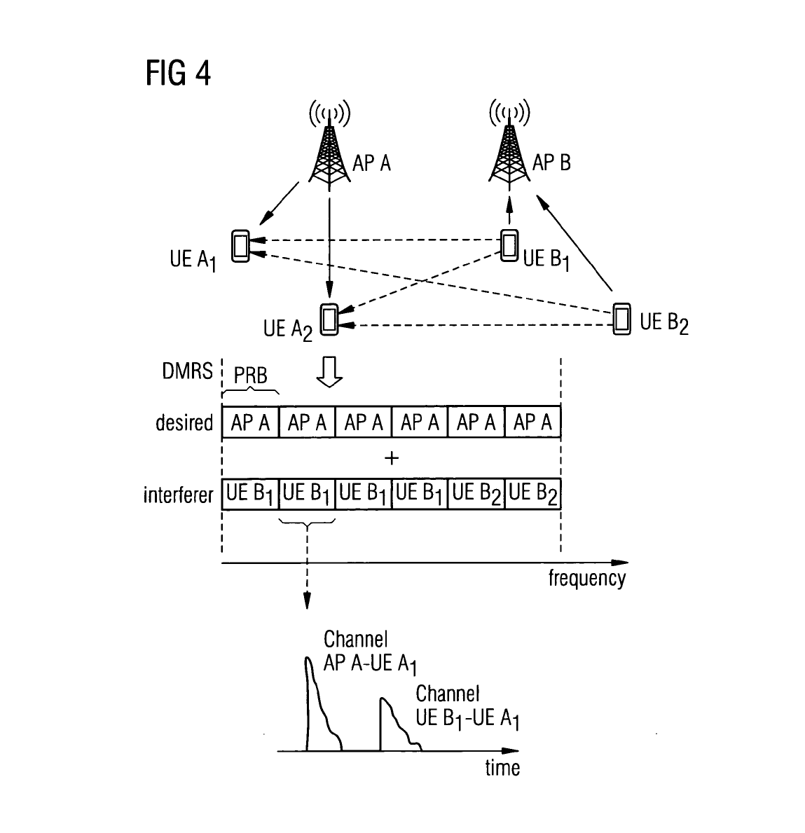

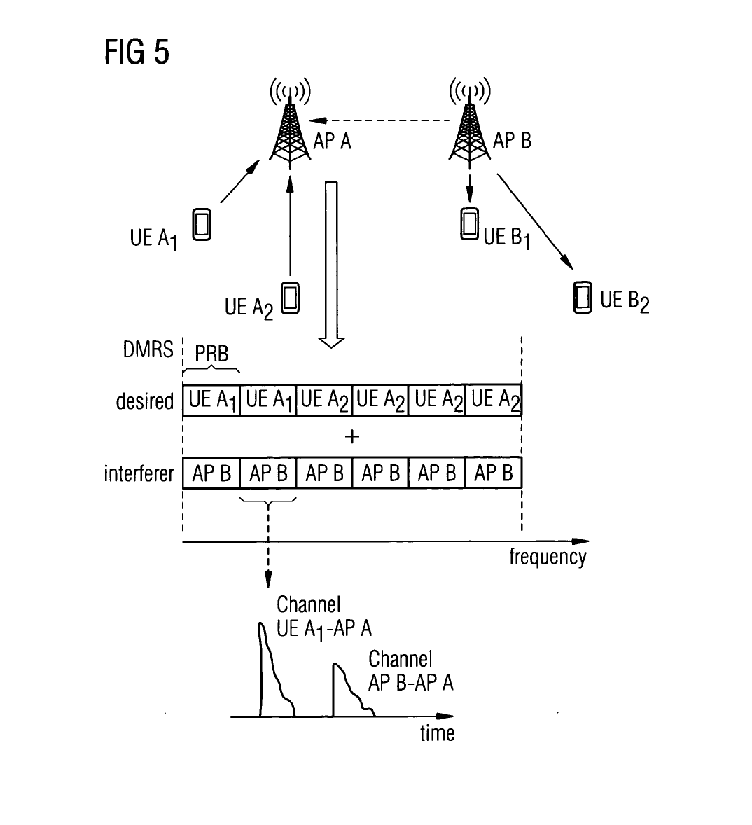

FIGS. 4 and 5 illustrate a technique according to an embodiment of the present invention;

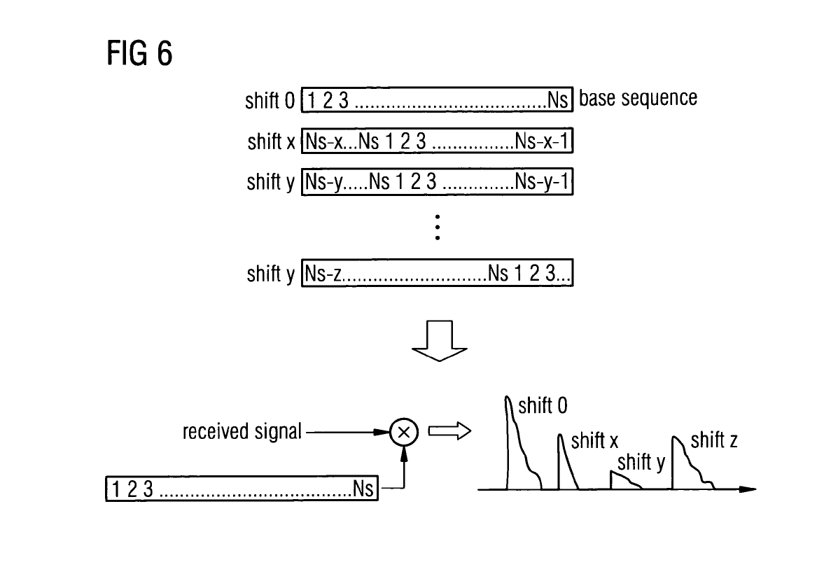

FIG. 6 illustrates an example of reference signals used in an embodiment of the present invention, and the processing of the reference signals at a receiving node;

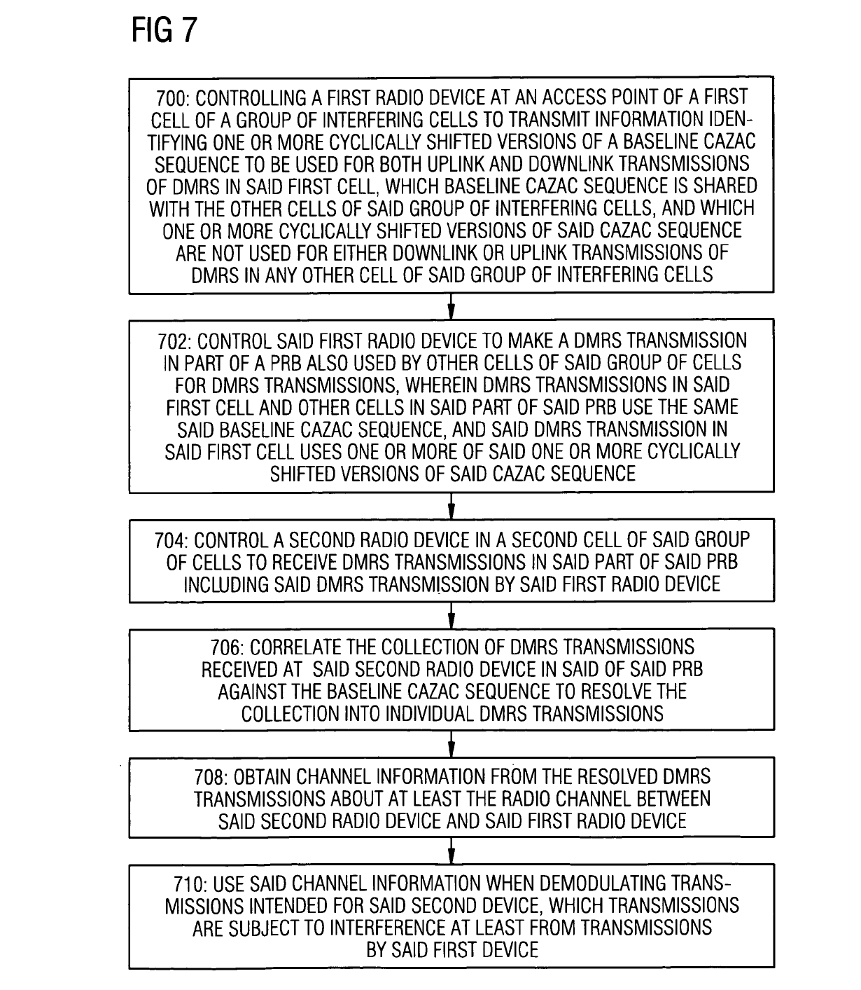

FIG. 7 illustrates an example of operations according to an embodiment of the present invention at an access point of a first cell and a UE or AP in a second, interfering cell receiving reference signals transmitted by said access point of said first cell; and

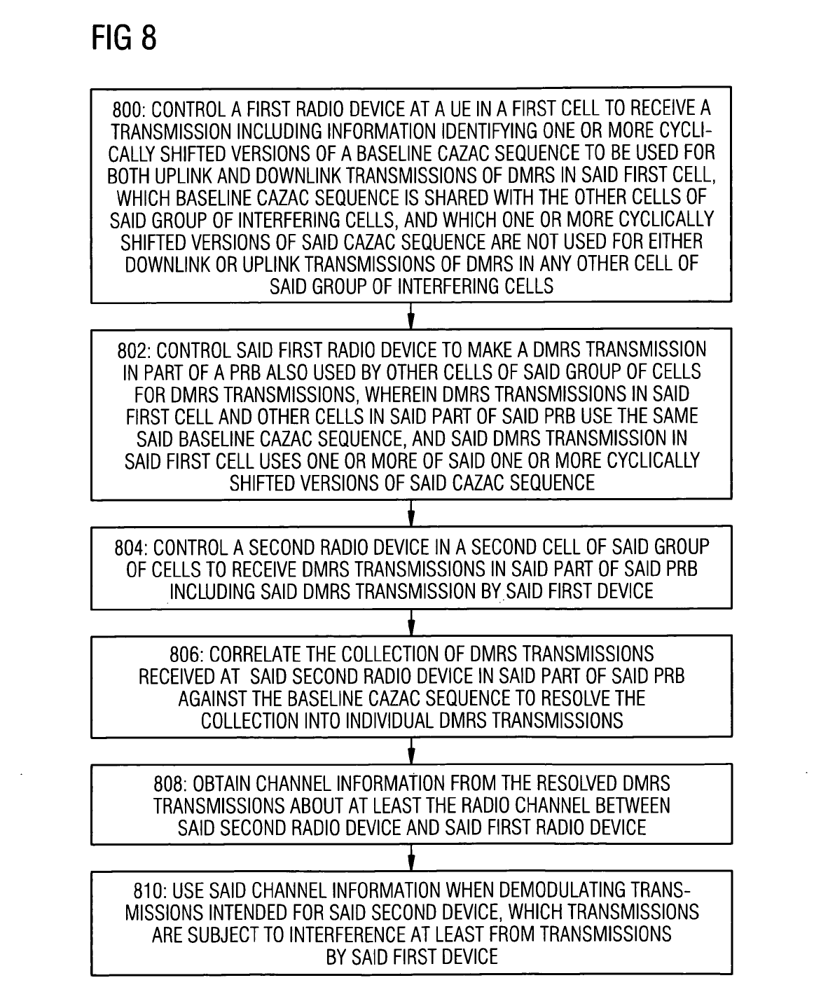

FIG. 8 illustrates an example of operations according to an embodiment of the present invention at a UE of a first cell and a UE or AP in a second, interfering cell receiving reference signals transmitted by said UE of said first cell.

An embodiment of the present invention is described in detail below for the example of an Evolved UTRAN (EUTRAN), but the same technique is also applicable to other kinds of radio access networks, such as Beyond 4^{th} Generation (B4G) or 5G.

FIG. 1 illustrates part of the architecture of one example of a cellular communication system in which embodiments of the present invention can be implemented. The exemplary cellular communication system includes a plurality of access nodes 2 respectively operating at least one cell.

In this example, the access nodes 2a, 2b are base stations (eNodeBs) of a EUTRAN, typically comprising thousands of such base stations, nodes, servers or hosts, each operating one or more cells. The coverage area of each cell typically depends on the transmission power, carrier frequency and the directionality of the antenna or set of antennas by which the cell is operated. Alternatively, the access nodes may be a combination of network entities such as a remote radio head and server or host.

The cellular communication system may comprise different kinds of access nodes operating cells of different coverage areas. For example, the cellular communication system may comprise macro access nodes 2a operating cells having relatively large coverage areas, and local area access nodes 2b operating cells having relatively small coverage areas.

The eNBs 2 are all connected to an Evolved Packet Core (EPC).

Only a small number of UEs 6 are shown in FIG. 1, but a EUTRAN would typically serve a very large number of UEs 6. Some examples of user devices (UEs) include mobile phones, smart phones, portable media players, tablets and other portable computer devices etc.

FIG. 2 shows a schematic view of an example of user equipment or user device (UE) 6 that may be used for communicating with the eNBs 2 of FIG. 1 via a wireless interface. The UE 6 may be any device capable of at least sending or receiving radio signals to or from the eNBs 2 of FIG. 1; and additionally may be capable of sending and receiving signals to from another UE in Device-to-Device (D2D) communications. D2D communication may be implemented as an underlay of a cellular network, such as Long Term Evolution (LTE) or Long Term Evolution Advanced. Thus, D2D communication may use cellular radio resources under the control of cellular network elements. Additionally, it is designed that beyond 4^{th} generation (B4G) or 5G systems will also support D2D communications. UE 6 may, for example, be a device designed for tasks involving human interaction such as making and receiving phone calls between users, and streaming multimedia or providing other digital content to a user. Non-limiting examples include a smart phone, and a laptop computer/notebook computer/tablet computer/e-reader device provided with a wireless interface facility.

The UE 6 may communicate via radio transceiver circuitry, unit or module 206 and associated antenna arrangement 205 comprising at least one antenna or antenna unit. The antenna arrangement 205 may be arranged internally or externally to the UE 2.

The UE 6 may be provided with: a baseband unit comprising one or more (baseband) processors 203; and at least one memory or data storage entity 217. The processor 203 and one or more memory entities 217 may be provided on an appropriate circuit board and/or in chipsets. The memory or data storage entity 217 is typically internal but may also be external or a combination thereof, such as in the case when additional memory capacity is obtained from a service provider.

In the cases of devices designed for human interaction, the user may control the operation of the UE 6 by means of a suitable user interface such as key pad 201, voice commands, touch sensitive screen or pad, combinations thereof or the like. A display 215, a speaker and a microphone may also be provided. Furthermore, the UE 6 may comprise appropriate connectors (either wired or wireless) to other devices and/or for connecting external accessories, for example hands-free equipment, thereto.

FIG. 3a shows one example of apparatus for use at the eNBs 2 of FIG. 1. The apparatus comprises or is coupled to a radio frequency antenna array 301 (comprising at least one antenna or antenna unit) configured to receive and transmit radio frequency signals; radio transceiver circuitry, module or unit 303 configured to interface the radio frequency signals received and transmitted by the antenna array 301; and a baseband unit comprising one or more (baseband) processors 306. The apparatus usually comprises an interface 309 via which, for example, the processor 306 can communicate with other network elements such as the core network (not shown). The processor 306 is configured to process signals from the radio transceiver 303. It may also control the radio transceiver 303 to generate suitable RF signals to communicate information to UEs 6, device 4a or other eNBs 2 via a wireless communications link, and also to exchange information with other network nodes 8 and/or other eNBs 2 across a wired link via the interface 309. The one or more memory or data storage units 307 are used for storing data, parameters and/or instructions for use by the baseband processor 306. The memory or data storage entity may be internal or external (locating in another network entity) or a combination thereof.

FIG. 3b illustrates another example of apparatus for use at the eNBs 2 of FIG. 1. The apparatus is the same as that of FIG. 3a except that the baseband unit comprising the (baseband) processor 306 is located remotely from the radio transceiver 303 and the antenna array 301, and is connected to the radio transceiver 303 by e.g. a fibre optic link 311.

The memories 207, 307 may be implemented using a suitable data storage technology, such as, for example, semiconductor based memory devices, flash memory, magnetic memory devices and systems, optical memory devices and systems, fixed memory and removable memory. The data processors 203, 306 may, for example, include one or more of microprocessors, digital signal processors (DSPs) and processors based on a multi-core processor architecture. The memory may also be external or the apparatus may use both an internal and external memory.

References below to processors 203, 306 controlling the operation of other elements of UEs 6 and eNBs 2b refer to the processors operating in accordance with program code stored at memories 207, 307.

It would be appreciated that the apparatus shown in each of FIGS. 2 and 3 described above may comprise further elements which are not directly involved with the embodiments of the invention described hereafter.

It should be appreciated that communication systems and apparatuses thereof will be integrated towards an infrastructure (more and more) based on undedicated and programmable hardware providing needed functionalities. A network element may be a computing equivalent device that gathers programmable resources based on virtualisation technologies.

An embodiment of the invention is described below for the example of facilitating the cancellation/mitigation of inter-cell interference between (i) downlink/uplink AP-UE transmissions in one cell, and (ii) downlink/uplink AP-UE transmissions in another cell, which interference arises from the relative location of the two cells (e.g. overlap of the geographical areas served by the two cells) and the sharing of radio resources between the two cells. However, the same kind of techniques also apply to inter-cell interference between other kinds of transmissions; such as inter-cell interference between transmissions between two UEs or between two access points (D2D transmissions or AP2AP transmissions) in one cell, and (b) D2D or AP2AP transmissions in one cell and AP-UE transmissions in one or more other cells, and vice versa. Transmissions by an AP for one or more UEs can be considered as downlink transmissions; transmissions by a UE for one or more APs can be considered as uplink transmissions; and transmissions by an AP for one or more other APs (AP2AP transmissions) or transmissions by an UE for one or more other UEs (D2D transmissions) can be considered either as downlink or uplink transmissions.

With reference to exemplifying FIGS. 4 and 5, some downlink and uplink transmissions in a first cell A operated by one eNB 2b (AP A) are made using radio resources that interfere with downlink and uplink transmissions in an overlapping cell B operated by another eNB 2b (AP B). For example, some transmissions in the two cells A and B may share the same time-frequency resources without any other kind of multiplexing (such as code division multiplexing) to distinguish different transmissions via the same time-frequency resources. Interference cancellation or interference mitigation techniques are typically used at the receiving nodes in each cell when demodulating transmissions subject to such interference from transmissions in one or more other cells. These interference cancellation/mitigation techniques use respective channel information about channels between the receiving device and one or more transmitting devices making interfering transmissions in one or more other cells. The timing of transmissions in cell A may be aligned with the timing of transmissions in cell B, regardless of whether the transmissions are in the same direction or not. In other words, transmissions in one direction (uplink or downlink) in cell A via any one time resource may be aligned with transmissions in cell B via the same one time resource, regardless of whether the transmissions are in the same direction or not. Not only is there alignment between the timing of transmissions in cells A and B, but both cells A and B may use aligned physical resource blocks (PRBs) for all transmissions in cells A and B. For the example of OFDM transmissions, a physical resource block may be defined by a predefined number of sub-carriers and a set of time resources defined by a predefined number of OFDMA symbols. Both data signals and reference signals including demodulation reference signals (DMRS) may be transmitted together in a single PRB by using a multiplexing technique. For the example of OFDM transmissions, the DMRS may be transmitted in one cell via a PRB are distinguished from data signals transmitted in the same cell via the same PRB by using different sub-carriers within the PRB and/or different OFDM symbols within the PRB. In the example of FIGS. 4 and 5, the DMRS for both cells A and B are transmitted in the same predefined part of the PRB.

For the example of cells operating according to half-duplex TDD (i.e. involving radio nodes/devices, which are not capable of transmitting and receiving at the same time), the processors 306 at the eNBs 2b operating these cells can independently decide whether to either receive or transmit in a PRB (i.e. use a PRB for one of either uplink or downlink transmissions in the cell), according to the individual needs of the respective cell. FIG. 4 shows an example of transmissions in the same PRBs by AP A and UEs served by cell B. FIG. 5 shows an example of transmissions in the same PRBs by AP B and UEs served by cell A.

In contrast to at least some other types of transmissions made in cells A and B, the transmissions of DMRS in both cells A and B in the same PRB may be distinguished from each other by e.g. the use of code division multiplexing. According to one example of code division multiplexing, transmission of DMRS in cell A in a PRB uses one or more cyclically shifted versions of a constant amplitude zero autocorrelation (CAZAC) sequence, regardless of whether the DMRS transmission is by a UE or by an AP (i.e. regardless of whether the DMRS is part of a downlink PRB or part of an uplink PRB), and transmission of DMRS in the same PRB in cell B uses one or more different cyclically shifted versions of the same CAZAC sequence, also regardless of whether the DMRS transmission is by a UE or by an AP (i.e. regardless of whether the DMRS is part of a downlink PRB or part of an uplink PRB). Adequate orthogonality at a receiving node between transmissions of different cyclically shifted versions of the same CAZAC sequence via the same time-frequency resources can be achieved by making the cyclic time shift value longer than the power delay spread of the channels between each transmitting nodes and the receiving node. Full orthogonality can be hard to achieve, but full orthogonality is not required for the interference mitigation techniques of this embodiment.

The access point of a cell transmits system information identifying the respective set of one or more cyclically shifted versions of the same CAZAC sequence used for both DL and UL transmissions of DMRS in that cell (STEP 700 of FIG. 7), and UEs served by that cell receive those transmissions (STEP 800 of FIG. 8) and use that information for making their DMRS transmissions in that cell.

FIG. 4 illustrates the example of a UE (UE A2) served by cell A and receiving transmissions from AP A that are subject to interference (or are potentially subject to interference) from at least transmissions by UEs served by cell B. At least one or more of the physical resource blocks are shared by AP A and UEs served by cell B. FIG. 4 shows an example in which 4 PRBs are shared by AP A and UE B1 and 2 PRBs are shared by AP A and UE B2, and the same predefined part of each PRB is used in each of cells A and B for transmitting DMRS. Because all downlink and uplink DMRS transmissions in cell A may use one or more cyclically shifted versions of a CAZAC sequence, and all uplink and downlink DMRS transmissions in cell B may use one or more different cyclically shifted versions of the same CAZAC sequence, there is no (significant) interference between the DMRS transmissions in cell A and the DMRS transmissions in cell B in the same predefined part of the same PRB, and any receiving node (e.g. UE A2) can obtain channel information for both the radio channel between UE A2 and e.g. AP A and the radio channel between UE A2 and e.g. UE B1 via the same PRB, as illustrated at the bottom of FIG. 4.

With reference also to the example of FIG. 7, the processors 203, 306 at AP A and UE B1 controls the transceivers 303, 206 of UE B1 and AP A to make DMRS transmissions in the same predefined part of the PRB using the respective set of one or more cyclically shifted versions of a CAZAC sequence allocated to the respective cell (STEP 702 of FIG. 7 and STEP 802 of FIG. 8). The processor 203 at UE A2 controls the transceiver to receive transmissions in said predefined part of said PRB (STEP 704 of FIG. 7 and STEP 804 of FIG. 8). The (baseband) processor at UE A2 resolves the DMRS transmissions received in said predefined part of said PRB into DMRS transmissions made by AP A and UE B1 (STEP 706 of FIG. 7 and STEP 806 of FIG. 8). The processor 203 at UE A2 obtains from the resolved DMRS transmissions channel information for the channel between AP A and UE A2 and for the channel between UE B1 and UE A2 (STEP 708 of FIG. 7 and STEP 808 of FIG. 8), and uses this channel information when demodulating e.g. data transmissions by AP A to cancel or mitigate interference from transmissions by UE B1 (STEP 710 of FIG. 7 and STEP 810 of FIG. 8).

FIG. 5 illustrates the example of AP A to receive transmissions from UE A1 and UE A2 served by cell A, which transmissions are subject to interference (or are potentially subject to interference) by at least transmissions by AP B. At least one or more of the physical resource blocks are shared by AP B and UEs served by cell A. FIG. 5 shows an example in which 2 PRBs are shared by UE A1 and AP B and 4 PRBs are shared by UE A2 and AP B, and the same predefined part of each PRB is used in each of cells A and B for transmitting DMRS. Because all downlink and uplink DMRS transmissions in cell A use one or more cyclically shifted versions of a CAZAC sequence, and all uplink and downlink DMRS transmissions in cell B use one or more different cyclically shifted versions of the same CAZAC sequence, there is no interference between the DMRS transmissions in cell A and the DMRS transmissions in cell B in the same predefined part of the same PRB, and any receiving node (e.g. AP A) can obtain channel information for both the radio channel between AP A and e.g. UE A2 and the radio channel between AP A and e.g. AP B via the same PRB, as illustrated at the bottom of FIG. 5.

With reference also to the example of FIG. 7, the processor 203, 306 at AP B and UE A1 controls the transceivers 206, 303 of AP B and UE A1 to make DMRS transmissions in the same predefined part of the PRB using the respective set of one or more cyclically shifted versions of a CAZAC sequence allocated to the respective cell (STEP 702 of FIG. 7 and STEP 802 of FIG. 8). The processor 306 at AP A controls the transceiver 303 of AP A to receive transmissions in said predefined part of said PRB (FIG. 704 of FIG. 7 and STEP 804 of FIG. 8). The processor 306 at AP A resolves the DMRS transmissions received in said predefined part of said PRB into DMRS transmissions made by AP B and UE A1 (STEP 706 of FIG. 7 and STEP 806 of FIG. 8). The processor 306 at AP A obtains from the resolved DMRS transmissions channel information for the channel between AP A and UE A1 and for the channel between AP A and AP B (STEP 708 of FIG. 7 and STEP 808 of FIG. 8), and uses this channel information when demodulating e.g. data transmissions by UE A1 to cancel or mitigate interference from transmissions by AP B (STEP 710 of FIG. 7 and STEP 810 of FIG. 8).

FIGS. 4 and 5 illustrate an example of a technique for achieving adequate orthogonality between DMRS signals in different cells in order to support the cancellation/mitigation of cross-channel interference between cells (i.e. interference between uplink transmissions in one cell and downlink transmissions in another cell), but the same kind of technique may also support the cancellation of co-channel interference between cells (i.e. interference between uplink transmissions in both cells, or interference between downlink transmissions in both cells).

Also, FIGS. 4 and 5 illustrate an example of a technique of supporting the cancellation/mitigation of interference from transmissions in one other cell. However, the technique may also be applied to supporting the cancellation/mitigation of interference from transmissions in a plurality of other cells. Cells may be collected into groups whose e.g. data transmissions exhibit a relatively high degree of interference with each other, because of the relative close proximity of the eNBs serving the cells. Each cell of the group may be allocated radio resources for DMRS transmissions which are excluded from use for DMRS transmissions in any other cell in the same group. For the example above of using different cyclically shifted versions of a CAZAC sequence to distinguish DMRS transmissions in different cells, each cell in the group is allocated a respective set of one or more cyclically shifted versions of the same CAZAC sequence. Adjacent groups of cells use different CAZAC sequences. Although an equally high level of orthogonality between DRMS transmissions in different groups may not be achieved, the choice of CAZAC sequences for adjacent groups is typically aimed at minimising cross-correlation between DMRS transmissions in one group of cells and DMRS transmissions in another group of cells.

Each cell of a group may be allocated more than one cyclically shifted version of the CAZAC sequence for the group. For example, a cell may be allocated N cyclically shifted versions of the CAZAC sequence, where N is the maximum transmission rank for the cell (i.e. N is the maximum number of spatial streams that can be used for a spatially multiplexed transmission in the cell, or the number of reception antennas at the access point operating the cell). For example, if a cell is configured to support 4×4 MIMO (multiple input multiple output) transmissions to/from UEs 6 with that capability, at least 4 different cyclically shifted versions of the CAZAC sequence are allocated to the cell. The maximum transmission rank may vary between cells in the group; and may be defined separately for each cell e.g. according to the type of access point operating the cell. The actual transmission rank used by a radio device in a cell may be less than the maximum transmission rank. In such cases, the baseband processor 203, 306 at the radio device making DMRS transmissions in the cell decides which of the plurality of N cyclically shifted versions to use for DMRS transmissions according to a predetermined rule. For example, if the N cyclically shifted versions allocated to a cell are denoted: [k, (k+1), (k+N−2), k+N−1], then the predetermined rule may be that: cyclically shifted version k is used when the actual transmission rank is 1; cyclically shifted versions k and (k+1) are used when the actual transmission rank is 2; and so on.

It should be understood that the principle described above may also be adapted to coordinated multipoint reception and transmission (CoMP).

The number of cells that can use the same CAZAC sequence will depend on how many cyclically shifted versions are required by each cell (depending on e.g. the maximum transmission rank for that cell), and the maximum delay spread between DMRS transmissions in the group of cells that share the same CAZAC sequence. For the example of an OFDM symbol of 16.67 μs duration and a delay spread of about 0.4 μs, up to about 40 cyclically shifted versions of the CAZAC sequence can be used; and if 4 cyclically shifted versions are allocated to each cell, the same CAZAC sequence could be used by a group of up to 10 cells to provide fully orthogonal DMRS transmissions within the group. In this way, the size of the group of cells will depend on the maximum transmission rank.

A cell may be part of more than one group of cells. For example, a cell may be part of a first group of cells for transmissions in a first frequency region of the frequency bandwidth allocated to the cell, and part of a second, different group of cells for transmissions in a second frequency region of the frequency bandwidth allocated to the cell. The cyclically shifted versions of the CAZAC sequence exclusively allocated within the first group of cells to DMRS transmissions in the first cell in the first frequency region may be used for DMRS transmissions in the second frequency region in one or more cells of the second group of cells not also included in the first group of cells. For example, the first frequency region may be primarily used (or reserved) for transmissions to or from UEs at the edge of the cell coverage area, where the number of interfering cells (or potentially interfering cells) may be relatively high (and, accordingly, the number of cells in the first group of cells may be relatively high); and the second frequency region may be primarily used (or reserved) for transmissions to or from UEs relatively close to the cell AP (2b), where the number of interfering cells may be relatively low (and, accordingly, the number of cells in the first group of cells may be relatively low). This kind of arrangement can better facilitate the efficient use of the limited number of cyclically shifted versions of a CAZAC sequence across cells, whilst ensuring an adequate degree of orthogonality between DMRS transmissions in geographical locations where inter-cell interference mitigation/cancellation is required. The maximum rank (and DMRS resource allocation) may be defined in a frequency-specific manner. For example, for some frequency resources (e.g. for some PRBs/group of PRBs), the maximum rank for the cell may be only two whereas for some other frequency resources (e.g. for some other PRBs/groups of PRBs), the maximum rank may be four. For example, this allows for tailoring the maximum rank (and DMRS resource allocation) for individual UEs according to the degree to which their geographical location renders them subject to inter-cell interference, and/or according to how close they are to the access point (AP). In the example described in the above paragraph, the maximum transmission rank in the first frequency region (for transmissions to/from UEs at the edge of the cell coverage area) may be relatively low (e.g. 2); and the maximum transmission rank in the second frequency region (for transmissions to/from UEs relatively close to the cell AP 2b may be relatively high (e.g. 4).

FIG. 6 illustrates an example of processing four or more DMRS transmissions in e.g. the same PRB at a receiving device. The processor 203, 306 at the receiving device may use a single correlator to distinguish DMRS transmissions by different transmitting devices (UE or eNB/AP) in the group of cells (and thereby obtain channel information about each of the radio channels between the receiving device and the respective transmitting device) by correlating the collection of signals received in the single PRB against the baseline CAZAC sequence. This channel information about the different radio channels may be used by the (baseband) processor 203, 306 at the receiving device when demodulating e.g. data transmissions intended for the receiving device. For example, the baseband processor 203, 306 at the receiving device uses the channel information derived from the DMRS transmissions to compute a covariance matrix, and uses the covariance matrix in an interference rejection/combining (IRC) technique. For example, a respective covariance matrix may be computed for each frequency block unit (e.g. frequency block for one PRB) via which the receiving device receives transmissions.

There will typically be a variation in the degree to which transmissions in other cells interfere with transmissions intended for a receiving device. The processor 203, 306 at the receiving device may follow a predetermined rule to only take into account interference by transmissions from transmitting devices whose DMRS transmissions are measured at the receiving device to have a power parameter that exceeds a predetermined threshold. This can simplify the process of computing the covariance matrices.

The CAZAC sequences for DMRS transmissions may be generated in different ways. For the example of making DMRS transmissions via an OFDM technique: relatively short baseline CAZAC sequences having a number of bins equal to the number of sub-carriers in a single PRB may be generated; and DMRS transmissions over a plurality of PRBs would use a plurality of staggered short sequences. Alternatively, a relatively long baseline sequence having a dimension equal to the number of subcarriers in the total bandwidth used by the group of cells may be generated; and DMRS transmissions over smaller bandwidths (e.g. a single PRB) would consist of a respective portion of the relatively long baseline sequence.

Embodiments described above support mitigation/cancellation of both co-channel interference and cross-channel interference between cells. This is of particular significance for cellular communication systems where (i) the relative proportion of transmissions by UEs and/or to access points (e.g. eNBs) becomes higher because of e.g. the increasing use of D2D communications and the increasing use of relay nodes in self-backhauling techniques, and (ii) it is desirable for each cell to be able to select a PRB for a downlink or uplink transmission independently of how the same PRB is used in neighbouring cells. It is also noted that embodiments described above are equally applicable to both single user MIMO (SU-MIMO) and multi-user MIMO (MU-MIMO) as well as any combinations thereof.

Embodiments described above do not require complicated signalling arrangements aimed at coordination of transmission rank for uplink and downlink. The transmission rank within the cell may vary dynamically within each cell. Without needing prior knowledge about the transmission rank of an interfering channel, a processor 203, 306 at a receiving node can blindly estimate the transmission rank of an interfering radio channel from the DMRS transmissions by the transmitting device for that radio channel, and accordingly adopt an optimum interference mitigation/cancellation strategy.

Embodiments of the invention have been described above for the example of using different cyclically shifted versions of a CAZAC sequence to distinguish between DMRS transmissions by different transmitters in a group of cells. However, other methods for achieving adequate orthogonality or sufficiently low cross correlation between DMRS transmissions by different transmitters in a group of cells are possible. For example, each cell in a group could use different time-frequency resources for its DMRS transmissions. Also, Walsh Hadamard codes can be used to separate DMRS transmissions in different cells. Furthermore, it is possible to use different CAZAC base sequences at different transmitters in a group of cells. It is also possible to use base sequences other than CAZAC sequences. Examples of other base sequences include ZAC sequences, computer search based sequences and, more generally, any base sequence that has the same kind of properties as a CAZAC sequence.

Embodiments of the invention have been described for the example of DMRS transmissions, but the same kind of techniques are also equally applicable to the transmission of other reference signals such as channel state information reference signals (CSI-RS) and sounding reference signals (SRS).

The program code mentioned above may include software routines, applets and macros. Program code may, for example, be copied into the one or more memories 207, 307 from any apparatus-readable non-transitory data storage medium. Computer program codes may be coded by a programming language, which may be a high-level programming language, such as objective-C, C, C++, C#, Java, etc., or a low-level programming language, such as a machine language, or an assembler.

The program code may be stored in a computer readable medium, such as a memory unit or magnetic or optical disk and it may be a non-transitory medium. The program code may also be loadable from a server, host or another suitable resource.

Alternatively, some of the above-described functions or other functions performed at UE 6 or eNB 2b may be implemented by one or more application specific integrated circuits (ASICs), chip sets, field programmable gate arrays (FPGAs), photonic integrated circuits, etc.

The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “fab” for fabrication.

In addition to the modifications explicitly mentioned above, it will be evident to a person skilled in the art that various other modifications of the described embodiment may be made within the scope of the invention.

1. A method comprising:
controlling a radio device of a first cell to transmit information identifying one or more radio resources allocated to both downlink and uplink transmissions of a type of reference signal in said first cell; and
controlling said radio device to transmit said type of reference signal in said first cell using said one or more radio resources; wherein the one or more radio resources are excluded from use for transmission of said type of reference signal in one or more other, interfering cells.

2. A method comprising:
controlling a radio device to receive information identifying one or more radio resources for both downlink and uplink transmissions of a type of reference signal in a first cell, and excluded from use for transmission of said type of reference signal in one or more interfering cells; and
controlling said radio device to transmit the type reference signal using the one or more radio resources.

3. The method according to claim 1, wherein said one or more radio resources comprises a respective radio resource for each antenna used by the radio device for spatially multiplexed transmissions in the cell.

4. The method according to claim 1, wherein the number of said one or more radio resources allocated to both uplink and downlink transmissions of said type of reference signal in said first cell is no smaller than the maximum transmission rank for spatially multiplexed transmissions in the first cell.

5. The method according to claim 1, wherein said one or more radio resources include at least a first set of one or more radio resources reserved for transmissions in the first cell in a first frequency region, and a second set of one or more radio resources reserved for transmissions in the first cell in a different, second frequency region.

6. (canceled)

7. The method of claim 1, wherein the type of reference signal is at least one of: demodulation reference signal, channel state information reference signal and sounding reference signal.

8. The method of claim 1, wherein the one or more radio resources used for both downlink and uplink transmissions in the first cell are at least substantially orthogonal to one more radio resources used for transmissions of said type of reference signal in said one or more other interfering cells.

9. The method of claim 1, wherein said first cell and said one or more other interfering cells comprise a group of cells, and said one or more radio resources is excluded from use for transmission of said type of reference signal in any other cell within said group of cells.

10.-18. (canceled)

19. An apparatus comprising: a processor and memory including computer program code, wherein the memory and computer program code are configured to, with the processor, cause the apparatus to:
control a radio device of a first cell to transmit information identifying one or more radio resources allocated to both downlink and uplink transmissions of a type of reference signal in said first cell; and
control said radio device to transmit said type of reference signal in said first cell using said one or more radio resources; wherein the one or more radio resources are excluded from use for transmission of said type of reference signal in one or more other, interfering cells.

20. An apparatus comprising: a processor and memory including computer program code, wherein the memory and computer program code are configured to, with the processor, cause the apparatus to:
control a radio device to receive information identifying one or more radio resources for both downlink and uplink transmissions of a type of reference signal in a first cell, and excluded from use for transmission of said type of reference signal in one or more interfering cells; and
control said radio device to transmit the type reference signal using the one or more radio resources.

21. The apparatus according to claim 19, wherein said one or more radio resources comprises a respective radio resource for each antenna used by the radio device for spatially multiplexed transmissions in the cell.

22. The apparatus according to claim 19, wherein the number of said one or more radio resources allocated to both uplink and downlink transmissions of said type of reference signal in said first cell is no smaller than the maximum transmission rank for spatially multiplexed transmissions in the first cell.

23. The apparatus according to claim 19, wherein said one or more radio resources include at least a first set of one or more radio resources reserved for transmissions in the first cell in a first frequency region, and a second set of one or more radio resources reserved for transmissions in the first cell in a different, second frequency region.

24. (canceled)

25. The apparatus according to claim 20, wherein the type of reference signal is at least one of: demodulation reference signal, channel state information reference signal and sounding reference signal.

26. The apparatus according to claim 19, wherein the one or more radio resources used for both downlink and uplink transmissions in the first cell are at least substantially orthogonal to one more radio resources used for transmissions of said type of reference signal in said one or more other interfering cells.

27. The apparatus according to any preceding claim 20, wherein said first cell and said one or more other interfering cells comprise a group of cells, and said one or more radio resources is excluded from use for transmission of said type of reference signal in any other cell within said group of cells.

28.-40. (canceled)

41. A computer program product comprising program code which when loaded into a computer controls the computer to:
control a radio device of a first cell to transmit information identifying one or more radio resources allocated to both downlink and uplink transmissions of a type of reference signal in said first cell; and
control said radio device to transmit said type of reference signal in said first cell using said one or more radio resources; wherein the one or more radio resources are excluded from use for transmission of said type of reference signal in one or more other, interfering cells.

42. A computer program product comprising program code which when loaded into a computer controls the computer to:
control a radio device to receive information identifying one or more radio resources for both downlink and uplink transmissions of a type of reference signal in a first cell, and excluded from use for transmission of said type of reference signal in one or more interfering cells; and
control said radio device to transmit the type reference signal using the one or more radio resources.

43.-44. (canceled)
